(19) United States
(12) Patent Application Publication
(10) Pub. No.: US 2015/0174853 A1
(43) Pub. Date: Jun. 25, 2015

(54) DECORATION FILM USING NATURAL CORK MATERIALS AND METHOD FOR MANUFACTURING THE SAME

(71) Applicant: Hyundai Motor Company, Seoul (KR)

(72) Inventor: Ho Tak Jeon, Hwaseong (KR)

(21) Appl. No.: 14/510,535

(22) Filed: Oct. 9, 2014

(30) Foreign Application Priority Data
Dec. 20, 2013 (KR) 10-2013-0159811

(51) Int. Cl. B32B 5/02; B32B 37/06; B32B 37/10; B32B 7/12; B32B 37/18

(52) U.S. Cl. CPC B32B 5/022; B32B 7/12; B32B 37/18; B32B 37/10; B32B 37/06; B32B 2250/03; B32B 2255/02; B32B 2255/26; B32B 2451/00; B32B 2605/003; B32B 2605/08

(57) ABSTRACT

Disclosed is a decoration film using natural cork materials which has cost competitiveness over the conventional real wood parts and can be manufactured in an open skin type by implementing natural wooden feature on the surface. Methods of manufacturing the decoration film are also disclosed. In particular, the decoration film using natural cork materials includes: a base material layer as the bottom layer; a middle layer bonded onto the base material layer; and a cork layer that is the top layer bonded onto the middle layer. The middle layer of the decoration film includes a bottom bonding layer, a non-woven fabric layer bonded onto the bottom bonding layer, and a top bonding layer bonded onto the non-woven fabric layer.

### CROSS-REFERENCE TO RELATED APPLICATION

This application claims under 35 U.S.C. §119(a) the benefit of Korean Patent Application 10-2013-0159811 filed on Dec. 20, 2013, the entire contents of which are incorporated herein by reference.

### TECHNICAL FIELD

The present invention relates to a decoration film using natural cork materials which has cost competitiveness over common real wood products, and a method for manufacturing the decoration film.

### BACKGROUND

Typically, interior parts such as a crash pad ahead of the driver's seat and the passenger's seat, a panel assembled with the crash pad around the dash board, a center fascia panel where an audio system, a cup holder, and an ashtray and the like are mounted, and a head lining as of roof member are disposed in a vehicle, and the interior parts are made of different materials.

Recently, interior materials made of real wood are used to achieve refined and elegant appearances.

In the related arts, conventional wooden products made of real wood are manufactured by preparing a base material; placing real wood member on the base material; and then coating/grinding the surface of the rear wood in finishing in which the surface of the real wood is polished and smoothed, thereby providing visually elegant features.

However, when the real wood products of the related art are used for forming automotive interior materials, or when formed parts such as automotive interior parts using the real wood materials of the related art are manufactured, the process may become complicated and the manufacturing cost may increase.

In addition, due to raw material cost of real wood, the above real wood products may not be used in general vehicles except for the high-end luxury vehicles. Moreover, since the real wood or wood sheets are required to be used with aluminum sheets and technical veneers due to fragile characteristics, the real wood products may not be manufactured in separate form, and therefore, the cross-sectional structures of the formed parts are substantially complicated (FIG. 5).

Accordingly, there is a need for a wood-finishing technology which may provide a simplified manufacturing process and cost competitiveness without deteriorating the quality of currently used real wood products.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a decoration film using natural cork materials that may have cost competitiveness over the currently used real wood parts and may be manufactured in an open skin type by using natural cork materials to implement wooden feature on the surface. Disclosed also is a method of manufacturing the decoration film.

In one aspect, provided is a decoration film using natural cork materials.

In an exemplary embodiment, the decoration film may include: a base material layer as the bottom layer; a middle layer bonded onto the base material layer; and a cork layer that is the top layer bonded onto the middle layer. The middle layer may include a bottom bonding layer; a non-woven fabric layer bonded onto the bottom bonding layer; and a top bonding layer bonded onto the non-woven fabric layer.

In certain exemplary embodiments, the non-woven fabric layer may be made of a long-staple non-woven fabric having density of about 10 g/m² to about 100 g/m². In yet certain exemplary embodiment, the non-woven fabric material for the non-woven fabric layer may be colored similar to or the same with the material of the cork layer.

In certain exemplary embodiments, the bonding materials for the top and bottom bonding layers may have a melting temperature of about 80 to about 200° C. In yet certain exemplary embodiments, the bonding materials for the top and bottom bonding layers may be, each independently, one or more selected from urethanes, acryls, esters, amides, thermoplastic polyurethane (TPU), and ethylene vinyl acetate (EVA), without limitation. Particularly, urethanes may be used for the top bonding layer and acryl may be used for the bottom bonding layer.

In certain exemplary embodiments, the material of the base material layer may be, but not limited to, selected from acrylonitrile-butadiene-styrene (ABS), a mixture of polycarbonate (PC) acrylonitrile-butadiene-styrene (ABS), and polyethylene terephthalate (PET), polypropylene (PP), polycarbonate (PC), and polymethyl methacrylate (PMMA). In particular, the material colored similar to or the same with the material of the cork layer may be used for the base material layer.

In certain exemplary embodiments, the cork layer may be made of the skin layer from soft parts of a cork tree.

In other aspect, methods of manufacturing the decoration film are provided.

In an exemplary embodiment, the method may include steps of: a first step of preparing a base material layer material, a middle layer material, and a cork layer material; and a second step of simultaneously laminating the materials and forming a film by cold-pressing the materials immediately after hot-pressing.

In certain exemplary embodiments, the hot-pressing may be performed at a temperature of about 120 to about 200° C. and cold-pressing may be performed at a temperature of about 10 to about 120° C. in the second step.

In certain exemplary embodiments, in the first step, the base material layer material and the middle layer material may be prepared in roll types and the cork layer material may be prepared in a sheet type.

In another aspect, a formed part for a vehicle is provided. The formed part may include: a base layer; a film layer made of a decoration film on the base layer; and a coating layer coated on the film layer. Particularly, the decoration film may include a base material layer, a middle layer bonded onto the base material layer, and a cork layer bonded onto the middle layer, and the middle layer may include a bottom bonding layer, a non-woven fabric layer bonded onto the bottom bonding layer, and a top bonding layer bonded onto the non-woven fabric layer.

According to various embodiments of the present invention, manufacturing a decoration film may be available for interior part materials of vehicles, at reduced cost, whereby the decoration film may be used not only for high-end luxury vehicles but also for ordinary mid-size and large-size vehicles to improve appearance of the interior materials. In addition, high quality visual effect may be obtained by using a cork pattern, and thus, commercial value may be enhanced by providing the surface of the interior parts with natural wooden feature in an open skin type. Moreover, since the bark of a cork tree is used without felling, an eco-friendly product may be obtained.

The above and other aspects of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is shows a cross-sectional structure of an exemplary decoration film according to an exemplary embodiment of the present invention;

FIG. 2 shows an exemplary lamination process of a decoration film according to an exemplary embodiment of the present invention;

FIG. 3 shows a cross-sectional structure of an exemplary formed part using a decoration film according to an exemplary embodiment of the present invention;

FIG. 4 illustrates an exemplary process of manufacturing an exemplary formed part for a vehicle according to an exemplary embodiment of the present invention; and

FIG. 5 shows a cross-sectional structure of a formed part in the related art.

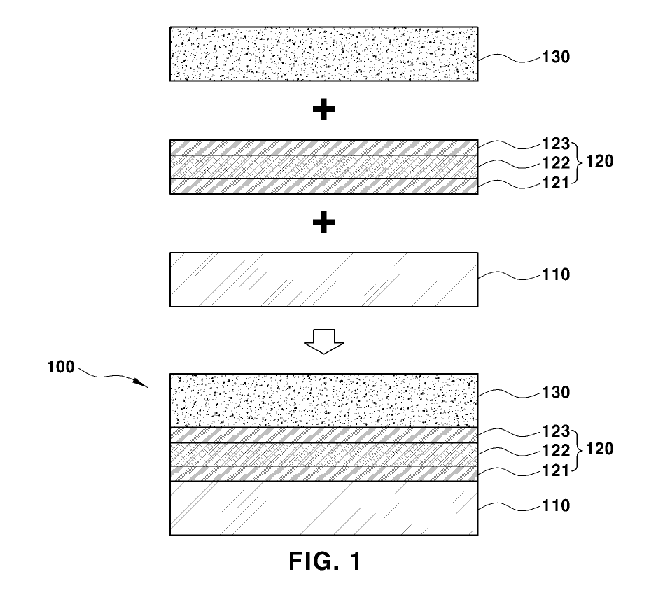

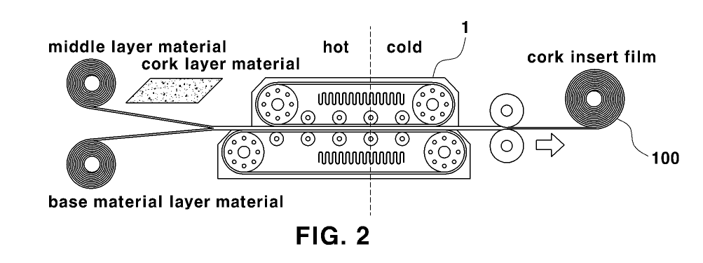

Reference numerals set forth in the FIGS. 1-5 include reference to the following elements as further discussed below:

| | |
|---|---|
| 100: decoration film (film layer) | 110: base material layer |

| | |
|---|---|
| 120: middle layer | 121: bottom bonding layer |
| 122: non-woven fabric layer | 123: top bonding layer |
| 130: cork layer | 120: formed part |

| | |
|---|---|
| 210: base layer | 220: coating layer |

It should be understood that the appended drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, the present invention will be described for those skilled in the art to easily achieve it.

As known in the art, during the growth of about 70 years, cork trees are used in eco-friendly ways by taking only the barks without felling, and their barks can be re-obtained after 10 years of taking barks.

Cork trees have good characteristics in addition to the unique elegant feature of natural materials, such as adiabaticity, sound insulation, electric insulation, and elasticity, and further have functional characteristics such as removing VOC (Volatile Organic Compound), emitting far infrared rays, deodorizing, and antibiosis.

Accordingly, the present invention provides a decoration film using a material from cork tree and a method of manufacturing the decoration film, thereby providing an economical technology which is capable of simplifying structure and manufacturing process as compared with those of the conventional natural wooden products and obtaining cost competitiveness.

In certain embodiments, the skin layer from the soft parts of natural cork trees may be used to manufacture a decoration film and an aqueous coating material may be used to prevent the surface properties of the formed part from discoloration, separation, and weariness using the film when the formed part is manufactured, such that an open skin type of formed part such as interior parts of vehicles may be obtained with wooden features on the surface.

Referring to FIG. 1, an exemplary decoration film 100 according to an exemplary embodiment of the present invention includes a cross-sectional structure with a base material layer 110, a middle layer 120, and a stacked cork layer 130. The decoration film 100 may include the base material layer 110 as the bottom layer, the middle layer 120 bonded onto the base material layer 110, and the cork layer 130 as the top layer bonded onto the middle layer 120.

In certain exemplary embodiments, the base material layer 110 may have a thickness of about 0.2 to 0.6 mm, the middle layer 120 may have a thickness of about 0.05 to 0.3 mm, and the cork layer 130 may have a thickness of about 0.1 to 1.0 mm.

In particular, the cork layer 130 may be made of the skin layer of the soft parts of the cork tree and may be fabricated in a glued timber formed by stacking and bonding thin cork sheets in a predetermined thickness. The cork layer 130 may have various cork patterns which may depend on the methods of stacking and slicing cork sheets for the cork layer 130.

Since the natural cork material is not an artificial material, there may exist holes, pores and scratches on the surface. When vacuum forming of the decoration film 110 is performed during manufacturing a formed part, the size of holes may increase or new holes may be produced due to partial expansion of the film 100, such that the base material layer 110 may be visually exposed to the naked eyes and the elegant feature of the surface of the film 100 may decrease.

Accordingly, the difference in external appearance and the feel of difference between the cork layer 130 and the base material layer 110 may be improved by applying a non-woven fabric in the middle layer 120.

In the related arts, using a short-staple non-woven fabric may cause separation between the interfaces in the decoration film 100. Accordingly, in certain exemplary embodiments, a long-staple non-woven fabric having a density of about 10 g/m² to 100 g/m² may be used in the middle layer 120. In yet certain exemplary embodiment, the long-staple non-woven fiber may be a spun-bonded type, since the fiber thereof is not cut while the fiber is ejected or spun. As such, the tensile strength may be greater than that of the short-staple non-woven fabric and interlayer separation may not occur. In still certain exemplary embodiments, a non-woven fabric colored in beige may be used for the non-woven fabric of the middle layer 120 to be matched with the color of the cork layer 130. In an exemplary embodiment, a long-staple fabric colored in beige may be used as of the non-woven fabric of the middle layer 120.

Referring to FIG. 1, in the middle layer 120, bonding layers 121 and 123 are disposed respectively on and under a non-woven fabric layer 122. The middle layer 120 may include the bottom bonding layer 121, the non-woven fabric layer 122 bonded onto the bottom bonding layer 121, and the top bonding layer 123 bonded onto the non-woven fabric layer 122. The top and bottom bonding layers 123 and 121 may be provided, respectively, for bonding between the cork layer 130 and the non-woven fabric layer 122 and between the non-woven fabric layer 122 and the base material layer 110. In certain exemplary embodiments, the materials of the bonding layers may be selected from, but not limited to, urethanes, acryls, esters, amides, thermoplastic polyurethane (TPU), ethylene vinyl acetate (EVA) and the like. In particular examples, among the amides, amide-based hot-melt adhesive may be used.

In yet certain exemplary embodiments, a material having a melting temperature of about 80 to 200° C. may be used for the bonding layer. When the melting temperature of the material for bonding layer is of about 200° C. or greater, the cork may be carbonized during stacking-bonding or laminating process.

In still certain exemplary embodiments, among materials with a melting temperature of about 80 to 200° C., the material for the bonding layer may be selected from urethanes, acryls, esters, amides, thermoplastic polyurethane (TPU), and ethylene vinyl acetate (EVA). In particular, a fabric type of hot-melt or hot-melt web material may be used for the top bonding layer 123 for bonding between the cork layer 130 and the non-woven fabric layer 122. In the related art, a convention hot-melt or adhesive of sheet or liquid adhesive used for the material of the top bonding layer may polish the surface of the cork layer 130 and deteriorate the elegant feature of the surface.

In certain exemplary embodiments, for a decoration film that is used for the interior parts of vehicles, a non-yellowing bonding layer with a thermal resistance at a temperature of about 120° C. or greater may be used as the top bonding layer to provide thermal resistance and light resistance.

In certain exemplary embodiments, the base material layer 110, which is in contact with an injection-molded material when a formed part using the decoration film 110 is manufactured, may be made of acrylonitrile-butadiene-styrene (ABS), a mixture of polycarbonate (PC) and acrylonitrile-butadiene-styrene (ABS), and synthetic resin such as polyethylene terephthalate (PET), polypropylene (PP), polycarbonate (PC), and polymethyl methacrylate (PMMA). In yet certain exemplary embodiments, the material which is same with or similar to the material in base material layer 110 may be used for the injection-molded material, thereby improving bonding with the base material layer 110. In an exemplary embodiment, the ABS material may be used without limitation as the material of the base material layer. In an exemplary embodiment, the material of the base material layer 110 may be colored to be matched with the color of the cork layer 130 by coloring in beige.

In other aspect, the decoration film 110 with the configuration as described above and shown in FIG. 1, may be manufactured by a belt roll type film lamination process or simply a belt roll lamination process.

In certain exemplary belt roll lamination process to manufacture the decoration film 110, the base material layer material for the base material layer 110 of the film 100 and the middle layer material for the middle layer 120 may be prepared in roll types, and the cork layer material for the cork layer 130 may be prepared in a sheet type with predetermined size and thickness. Particularly, the belt roll lamination process may be optimized for stacking and bonding roll type and sheet type of materials and may continuously produce the decoration film 100 into roll type films in large quantities. Therefore, using the belt roll type lamination process in manufacturing the decoration film 100 may be advantageous by improving productivity of the decoration film 100 due to continuous mass production.

In certain exemplary embodiments, for the middle layer material, the materials for the top bonding layer 123, the non-woven fabric layer 122, and the bottom bonding layer 121 of the middle layer 120 may be stacked-bonded in three layers, rolled before lamination process, and laminated. Alternatively, though not shown in the figures, the materials for the top bonding layer 123, the non-woven fabric layer 122, and the bottom bonding layer 121 may be independently rolled and then laminated. In other certain exemplary embodiments, the cork layer 130, top bonding layer 123, and non-woven fabric layer 122 may be stacked-bonded in three layers before a lamination process, rolled, and then laminated. Further, as the cork layer material, the base material layer material and the middle layer material which are not in roll types but in sheet types may be prepared separately and the belt roll lamination process may be performed on those, thereby manufacturing a film.

In certain exemplary embodiment, in the belt roll lamination process, the materials may be fed simultaneously to a laminating machine 1 and stacked-bonded through the laminating machine 1, in which hot pressing may be performed at the inlet of the laminating machine 1 and cold pressing may be performed at the outlet of the laminating machine 1. In such belt roll lamination process, the materials of a film may be primarily hot-pressed, and subsequently and immediately, cold-pressed to be bonded by stacking-bonding through the laminating machine 1.

As such, distortion and deformation of the base material layer material may be prevented or minimized and further post-deformation such as bending, distortion and the like may be prevented due to the cork layer material.

In certain exemplary embodiments, the laminating process may be performed at a temperature greater than the melting temperature of the bonding materials of about 80 to about 200° C. Particularly, in the stacking-bonding or lamination process, the base material layer material, the middle layer material, and the cork layer material may be pressed at a temperature of about 120 to 200° C. in hot-pressing in consideration of the melting temperature of the bonding material of bonding layer material used for the middle layer 120 and the temperature range for preventing carbonization of the cork layer material, thereby optimizing the lamination process. In certain exemplary embodiments, in the lamination process, the hot-pressing may be performed at a temperature relatively greater than that of the cold-pressing, particularly at a temperature of about 120 to 200° C.; and the cold-pressing may be performed at a temperature of about 10 to 120° C.

In another aspect, a formed part 200 for interior materials of vehicles may be manufactured using the decoration film 100 manufactured through the lamination process.

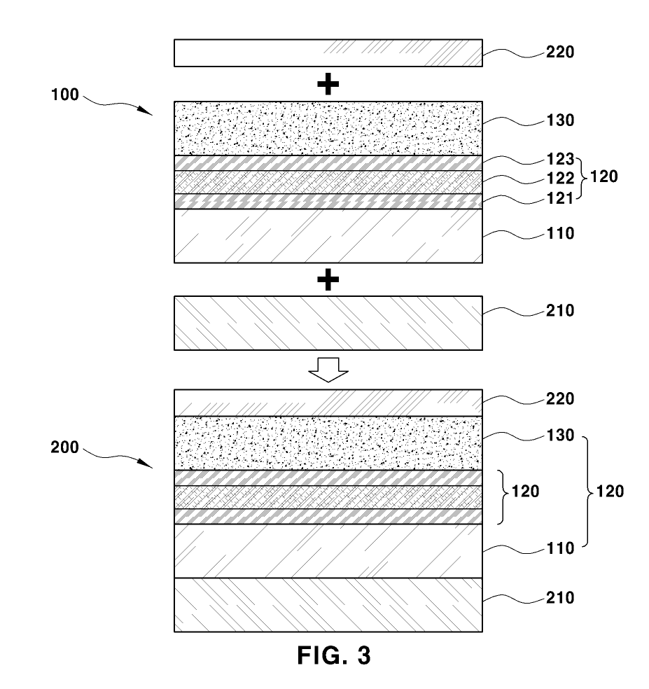

Referring to FIG. 3, the formed part 200 may have total three layers, including the decoration film 100. The decoration film 100 may include a base layer 210 made of an injection-molded material, a film layer 100 made of a decoration film on the base layer 210, and a coating layer 220 coated on the film layer 100. In certain exemplary embodiments, the thickness of the base layer 210 may be of about 2.5 mm.

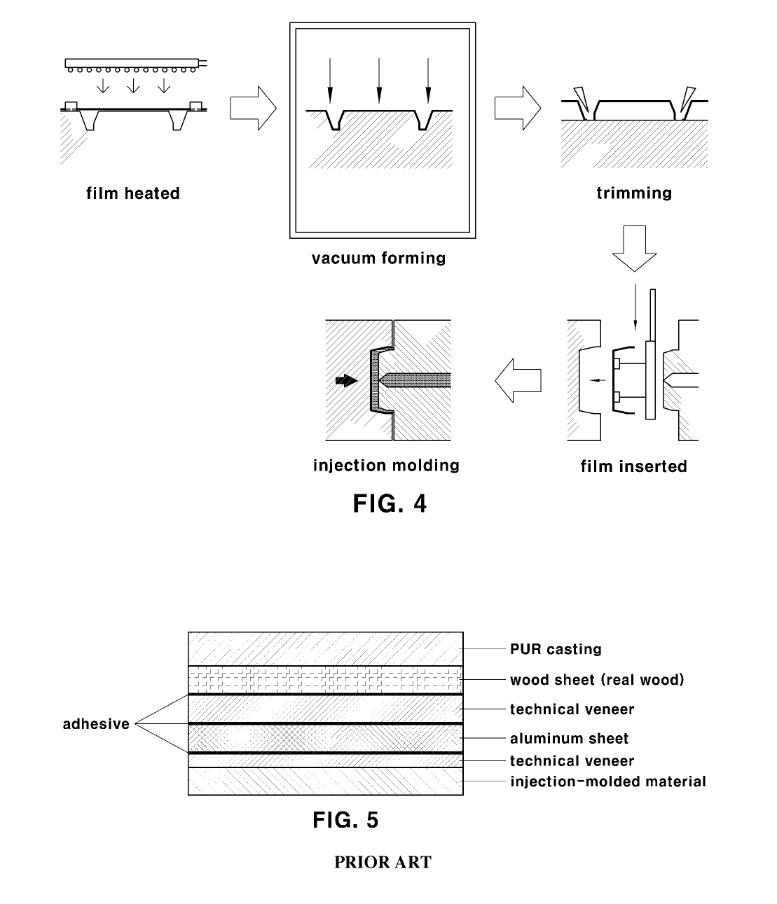

FIG. 4 schematically shows a portion of an exemplary process of forming and manufacturing the formed part 200 according to an exemplary embodiment of the present invention.

Referring to FIG. 4, the formed part 200 may be formed in a predetermined shape through film preheating, vacuum forming, and trimming, and the base layer 210 may be formed under the film layer 100 through insert extraction.

The film preheating refers to a process of preheating the decoration film 100 before the vacuum forming. In certain exemplary embodiments, in the preheating, the decoration film may be heated for about 5 to about 90 seconds at a temperature less than or equal to the melting temperature of the bonding material, and then the vacuum forming may be performed. When the film is preheated for less than about 5 seconds, the film may not be formed completely or surface cracks may be generated in the vacuum forming. When the film is heated for greater than about 90 seconds, sagging, deformation, and interlayer separation of the decoration film may occur.

The vacuum forming refers to a process of forming the film layer by forming the preheated decoration film into a desired shape under vacuum. In certain exemplary embodiments, press forming may be used instead of the vacuum forming.

The trimming refers to a process of finishing the film layer 100 formed by the vacuum forming into a predetermined shape by cutting the edges of the film 100.

The insert injection molding refers to a process of forming the base layer 210 by injecting an injection-molded material into a mold, after putting the trimmed film layer 100 into the mold.

The preheating, vacuum forming, trimming, film inserting, and injection molding that are performed on the film are well known in the art, without any limitations.

In certain exemplary embodiments, as described above, the base layer 210 may be formed under the film layer 100 formed in a predetermined shape, and subsequently the coating layer 220 may be formed on the film layer 100. After the insert injection molding, durability of the surface of the formed part 200 may be obtained and an open skin type of natural wooden features on the surface may be achieved by applying stain painting or clear painting to the top of the film layer 100.

The process of forming the coating layer 220 by applying a coating material to the top of the film layer 100 may include: color stain applying, drying, clear applying, drying, surface sanding, clear applying, drying, and completing product or coating layer. Alternatively, a primer may be applied to improve bonding ability between the color stain applying and the clear applying.

In certain exemplary embodiments, the clear applying may be performed two times when forming the coating layer 220, particularly, when acrylic-urethane type of paint is used. When the clear applying is performed once, the cork layer material of the film layer 100 may absorb the clear paint, such that the coating layer 220 may be not be completed or the surface performance may deteriorate.

In certain exemplary embodiments, in the color stain applying, which is a type of application using color paints including coloring paints, a natural color may be applied to the film layer 100 by forming a color coating layer. In yet certain exemplary embodiments, the clear applying, which is a type of application using clear paints without a coloring paint, may form a transparent coating layer or a translucent coating layer including colored, semi-colored, non-colored coating layer. Accordingly, durability of the surface may be improved by providing the coating layer 220 with light resistance, wear resistance, scratch resistance, chemical resistance and the like.

Although embodiments of the present invention were described in detail above, the scope of the present invention is not limited thereto and various changes and modifications from the spirit of the present invention defined in the following claims by those skilled in the art are also included in the scope of the present invention.

The invention has been described in detail with reference to various exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A decoration film using natural cork materials, comprising:
a base material layer as the bottom layer;
a middle layer bonded onto the base material layer; and
a cork layer that is the top layer bonded onto the middle layer,
wherein the middle layer includes a bottom bonding layer, a non-woven fabric layer bonded onto the bottom bonding layer, and a top bonding layer bonded onto the non-woven fabric layer.

2. The decoration film of claim 1, wherein the non-woven fabric layer is made of a long-staple non-woven fabric having a density of about 10 g/m² to 100 g/m².

3. The decoration film of claim 1, wherein a non-woven fabric material colored similar to or the same with the color of the material of the cork layer is used for the non-woven fabric layer.

4. The decoration film of claim 1, wherein a bonding material having a melting temperature of about 80 to 200° C. is used independently for the top and bottom bonding layers.

5. The decoration film of claim 4, the bonding material of the top and bottom bonding layers is, each independently, one or more selected from urethanes, acryls, esters, amides, thermoplastic polyurethane (TPU), and ethylene vinyl acetate (EVA).

6. The decoration film of claim 1, wherein a material for of the base material layer is one or more selected from acrylonitrile-butadiene-styrene (ABS), a mixture of polycarbonate (PC) acrylonitrile-butadiene-styrene (ABS), and polyethylene terephthalate (PET), polypropylene (PP), polycarbonate (PC), and polymethyl methacrylate (PMMA).

7. The decoration film of claim 1, wherein a material colored similar to or the same with the color of the material of the cork layer is used for the base material layer.

8. The decoration film of claim 1, wherein the cork layer is made of a skin layer from soft parts of a cork tree.

9. The decoration film of claim 1, wherein the base material layer has a thickness of about 0.2 to 0.6 mm, the middle layer has a thickness of about 0.05 to 0.3 mm, and the cork layer has a thickness of about 0.1 to 1.0 mm.

10. A method of manufacturing a decoration film, comprising steps of:
a first step of preparing a base material layer material, a middle layer material, and a cork layer material; and
a second step of simultaneously laminating the materials and forming a film by cold-pressing the materials immediately after hot-pressing.

11. The method of claim 10, wherein, in the second step, the hot-pressing is performed at a temperature of about 120 to 200° C.

12. The method of claim 10, wherein, in the second step, the cold-pressing is performed at a temperature of about 10 to 120° C.

13. The method of claim 10, wherein, in the first step, a material for the base material layer and a material for the middle layer material are prepared in roll types and a material for the cork layer is prepared in a sheet type.

14. A formed part comprising:
a base material layer;
a film layer made of a decoration film on the base material layer; and
a coating layer coated on the film layer,
wherein the decoration film includes a base material layer, a middle layer bonded onto the base material layer, and a cork layer bonded onto the middle layer, and
the middle layer includes a bottom bonding layer, a non-woven fabric layer bonded onto the bottom bonding layer, and a top bonding layer bonded onto the non-woven fabric layer.

15. The formed part of claim 14 which is a vehicle interior part.
